(19) United States
(12) Patent Application Publication
(10) Pub. No.: US 2021/0295389 A1
(43) Pub. Date: Sep. 23, 2021

(54) INTERFACE FOR COOPERATIVE CONTENT REVIEW

(71) Applicant: Covault Technologies Inc., Victoria (CA)

(72) Inventors: Graeme Douglas Csath, Victoria (CA); Jeffrey Michael Simpson, Victoria (CA); Amber China Simpson, Victoria (CA)

(21) Appl. No.: 16/825,893

(22) Filed: Mar. 20, 2020

(51) Int. Cl. G06Q 30/02; G06F 16/176; G06Q 10/10

(52) U.S. Cl. CPC G06Q 30/0276; G06Q 10/101; G06F 16/176; G06Q 30/0273

(57) ABSTRACT

Content from a first user including a template, a logo and an image is uploaded to a system. Content from a second user, which may include a message, is also uploaded and combined with the first content to form cooperatively produced content. The second user inputs price information for publishing the cooperatively produced content. The first user reviews the cooperatively produced content and the price information via an interface that simultaneously displays both.

### TECHNICAL FIELD

The invention relates to a system for cooperation between different parties that wish to publish content. More specifically, it relates to an interface for cooperative content review prior to publication.

### BACKGROUND

In certain cases, an efficient process for collecting data from multiple parties or stakeholders in a project, and to implement a selling strategy for a company's goods and services, can be synonymous with efficient and economic market expansion. For example, delivering a targeted approach can improve the success of an advertisement campaign compared to a broadcast approach.

For example, the process of generating an advertisement may be sensitive to constraints imposed by potentially several stakeholders, including various content owners, the set of retailers or dealers providing the products, as well as the product attributes. Generally, it is a tedious and slow process to collaboratively prepare advertisements because of the multiple parties involved, the fact that the cost of the advertisements are often shared between multiple parties, and the lack of streamlining in the process. Often, such a process can take several weeks.

This background is not intended, nor should be construed, to constitute prior art against the present invention.

### SUMMARY OF INVENTION

The present invention is related to a system that enables cooperation for generating advertisements tailored to multiple customer(s) requirements in a fast and timely manner. The system hosts and retrieves data from the various stakeholders or contributors in order to combine, render and publish content in line with a set of prerequisite approvals and conditional validations that are enforced during the cooperative process.

A user interface allows the writer of the advertisements to simultaneously review the advertisements that have been created, select an advertising spend per week, and select a number of weeks for the advertisements to run. Another user interface that simultaneously displays the advertisements and total spend allows an approver and/or stakeholder who is contributing to the cost of the advertisements to approve the advertisements and proposed spend associated with the advertisements. Simultaneous display of the various components on the interfaces makes the process convenient for the parties concerned.

### BRIEF DESCRIPTION OF THE DRAWINGS

The following drawings illustrate embodiments of the invention, which should not be construed as restricting the scope of the invention in any way.

FIG. 1 is a block diagram that shows the various stakeholders interacting with the cooperative system, according to an embodiment of the present invention.

FIG. 2 is a drawing that shows the GUI of the system seen by the dealer, according to an embodiment of the present invention.

FIG. 3 is a drawing that shows the GUI of the system seen by the brand, according to an embodiment of the present invention.

FIG. 4 is a flowchart that shows a process of the system, according to an embodiment of the present invention.

FIGS. 5A and 5B are a detailed swimlane diagram that shows the process, according to an embodiment of the present invention.

FIG. 6 is a detailed flowchart of the process from the dealer's point of view, according to an embodiment of the present invention.

FIG. 7 is a detailed flowchart of the process from the brand's point of view, according to an embodiment of the present invention.

FIG. 8 is a block diagram that describes the system, according to an embodiment of the present invention.

### DESCRIPTION

### A. Glossary

Advertisement campaign—refers to a promotional activity that is organized by a dealer via social media, for example.

Brand—refers to the company, department or stakeholder that is responsible for making a good or providing a service. It also may mean an employee of the brand, particularly when the brand is described as interacting with the system.

Dealer—refers to the subsidiary, franchisee, department or stakeholder that is responsible for selling a good or a service to the general public. It also may mean an employee of the dealer.

DSM—district sales manager.

The term “firmware” includes, but is not limited to, program code and data used to control and manage the interactions between the various modules of the system.

GUI—graphic user interface.

The term “hardware” includes, but is not limited to, the physical housing for a computer as well as the display screen, connectors, wiring, circuit boards having processor and memory units, power supply, and other electrical or electronic components.

The term “module” can refer to any component in this invention and to any or all of the features of the invention without limitation. A module may be a software, firmware or hardware module, and may be located in a user device or a server.

The term “network” can include both a mobile network and data network without limiting the term's meaning, and includes the use of wireless (e.g. 2G, 3G, 4G, 5G, WiFi, WiMAX™, Wireless USB (Universal Serial Bus), Zigbee™, Bluetooth™ and satellite), and/or hard wired connections such as local, internet, ADSL (Asymmetrical Digital Subscriber Line), DSL (Digital Subscriber Line), cable modem, T1, T3, fibre, dial-up modem, television cable, and may include connections to flash memory data cards and/or USB memory sticks where appropriate. A network could also mean dedicated connections between computing devices and electronic components, such as buses for intra-chip communications.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. The processor, if comprised of multiple processors, may be located together or geographically separate from each other. The term includes virtual processors and machine instances as in cloud computing or local virtualization, which are ultimately grounded in physical processors.

The term “sales program” relates to promotional activity that a brand launches. A sales program may include individual advertisement campaigns launched within the sales program by different dealers.

The term “software” includes, but is not limited to, program code that performs the computations necessary for calculating and optimizing user inputs, the reporting and analysis of product specific data, displaying information, and, managing of input and output data.

Stakeholder—refers to a person or entity that interacts with the system, and has a vested interest in the content that is prepared and published using the system. A stakeholder may be, for example, a brand or a dealer. A stakeholder may also be a company, department of a company or employee of the company that makes the system available or provides services related to use of the system.

System—refers to a system for allowing collaboration between multiple stakeholders for the review and publication of content.

The term “user” refers to a person who uses the system or interacts with it via a user device. There may be different types of user, such as a dealer, a brand, a media buyer, a DSM, an administrator of the system or any other stakeholder.

### B. Exemplary Apparatus

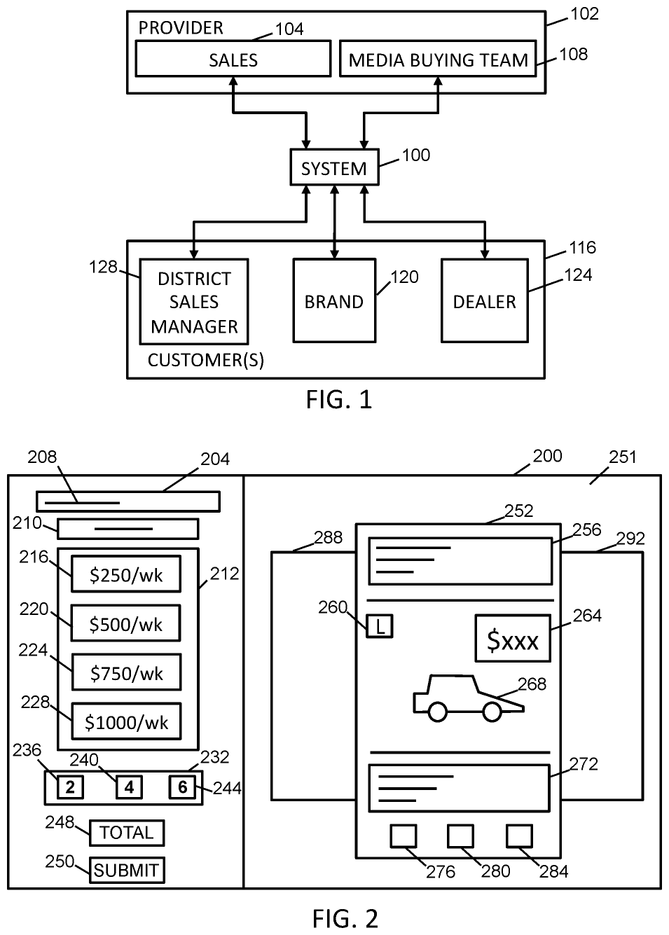

Referring to FIG. 1, there is shown a block diagram describing the various stakeholders that use the system 100. The provider or supplier 102 includes, for example, the sales department 104 and the media buying team 108 of the company that owns or operates the system 100. The sales department may be, for example, responsible for selling advertisements or advertising campaigns to customers 116. The media buying team 108 may be responsible for buying advertising impressions on social media, for example. The system 100 interacts with both the sales team 104 and the media buying team 108.

The customer(s) 116 include, for example, the brand 120, the dealer 124 and the district sales manager 128 or DSM. The brand may be, for example, the manufacturer of automobiles. The dealer may be, for example, a dealer that sells such automobiles in a specific geographic region. A DSM 128 may be, for example, a person that is responsible for sales across multiple dealerships. In some embodiments, the customer(s) 116 include further stakeholders such as a client, for example. The system 100 interacts with the district sales manager 128, the brand 120 and the dealer 124.

Referring to FIG. 2, there is shown an advertisement campaign graphic unit interface 200 or GUI of the present system 100 that is seen by the dealer 124 during use of the system. Prior to displaying the GUI 200 to the dealer 124, the dealer, via the system 100, has selected templates, advertising content, such as images, logos, price format, offer dates etc., and the system has compiled these selections with dealer-specific content such as the dealer's location, dealer-specific pricing and offer description or other message. As such, the dealer 124, using the system 100, has prepared one or more advertisements using predefined images and logos that cannot be changed or altered by the dealer. In some embodiments, the logos and images can be repositioned within the template by the dealer 124. Once the advertisements have been prepared, the GUI 200 is then displayed to the dealer 124 in order to allow him to choose the duration and spend of the advertisement campaign he wants. In the upper left part of the GUI 200, there is an area 204 allocated to the title 208 of the advertisement campaign. In some embodiments, the area 204 includes additional information to describe the advertisement campaign. In some embodiments, the type of information is the description of a special offer. For example, the special offer may relate to the launch of a new product or a special discount for a previously launched product. The type of information is chosen to provide an idea about the main incentive or purpose of the advertisement campaign.

Below the area 204, there is an area 210 that displays a short descriptive subtitle for the advertisement campaign. For example, this subtitle introduces a financial incentive or discount for the new advertisement campaign for the dealer from the brand. This subtitle may provide a quantified indication of the financial incentive for the new advertisement campaign. For example, the subtitle 210 may state the percentage of the advertising cost that will be reimbursed to the dealer 124 by the brand 120, on the assumption that the dealer pays the advertisers the full cost.

An area 212 at the center left side of the GUI 200 has four vertically aligned boxes 216, 220, 224 and 228. Each one of the four boxes 216, 220, 224 and 228 displays an option of a price per week, which corresponds to the total cost of the advertisements per week. For example, the prices may be $250/week, $500/week, $750/week and $1000/week respectively. The dealer has to select one of the boxes 216, 220, 224 or 228 in order to select an option of price per week. In some embodiments, the area 212 displays other than four boxes. In some embodiments, the boxes 216, 220, 224 and 228 are displayed differently. For example, the boxes 216, 220, 224 and 228 may be displayed in a grid or in a non-aligned manner.

On the lower left part of the GUI 200, there is an area 232 that contains three horizontally aligned boxes 236, 240 and 244. Each one of the three boxes 236, 240 and 244 displays the option of a number of weeks to be selected by the dealer for the advertisement campaign to run. For example, the numbers of weeks in the boxes 236, 240, 244 may be 2, 4 and 6 respectively. Below the area 232, there is an area 248 that indicates the projected total advertisement spend, based on multiplying the number of weeks selected by the price per week selected. The button 250 is used by the dealer to submit the advertisement campaign to the brand, for example.

In some embodiments, the selection of the number of weeks via a click on box 236, 240 or 244 and the price via a click on box 216, 220, 224 or 228 triggers the submission of the advertisement campaign without the use of the submission button 250.

On the right side of the GUI 200, there is an area 251 showing one of the advertisements 252 that the dealer 124 has compiled using a template, image and logo provided by the brand 120. The advertisement 252 may therefore be referred to as cooperatively produced content. An area 256 at the top of the advertisement 252 displays a summary description of the advertisement offer, which the dealer has written, for example. In the central part of the advertisement 252, on the left side, there is a box 260 that displays the logo of the brand 120. On the right side of the central part of the advertisement 252, there is a box 264 that displays the price of the vehicle. It may be a total price or a monthly lease price, for example. An image of the vehicle 268 is positioned below the boxes 260 and 264.

At the bottom of the advertisement 252, there is an area 272 that displays a more detailed written description of the offer, again that the dealer 124 has written. Below the box 272, there are three horizontally aligned boxes 276, 280 and 284. Each one of the boxes 276, 280 and 284 represents a function from a social network such as a like function, a comment function and a share function. In some embodiments, more boxes with additional functions are displayed.

Behind the advertisement 252, there are two additional advertisements 288 and 292 positioned in the background. A click on one of the advertisements 288 or 292 brings the clicked advertisement to the foreground in place of advertisement 252. In some embodiments, the three advertisements 252, 288 and 292 are arranged in the same plane, for example as thumbnails, with each one coming to the foreground when the cursor is moved over it. In some embodiments, there are other than three windows, depending on the number of advertisements.

The advertisements 252, 288, 292 appear in the GUI 200 exactly as they would appear when published, taking into account the different devices and browsers in which they may be displayed.

The main features of the GUI 200 are an area 251 for viewing the advertisements 252, 288, 292 that have been prepared and an area 212, 232 that is displayed for selecting the advertisement spend, both areas being displayed simultaneously. The area 212, 232 for selecting the advertisement spend is, in some embodiments, divided into two separate areas with one of these areas 212 for selecting the spend per week and the other of these areas 232 for selecting the total number of weeks that the advertisements are to be placed.

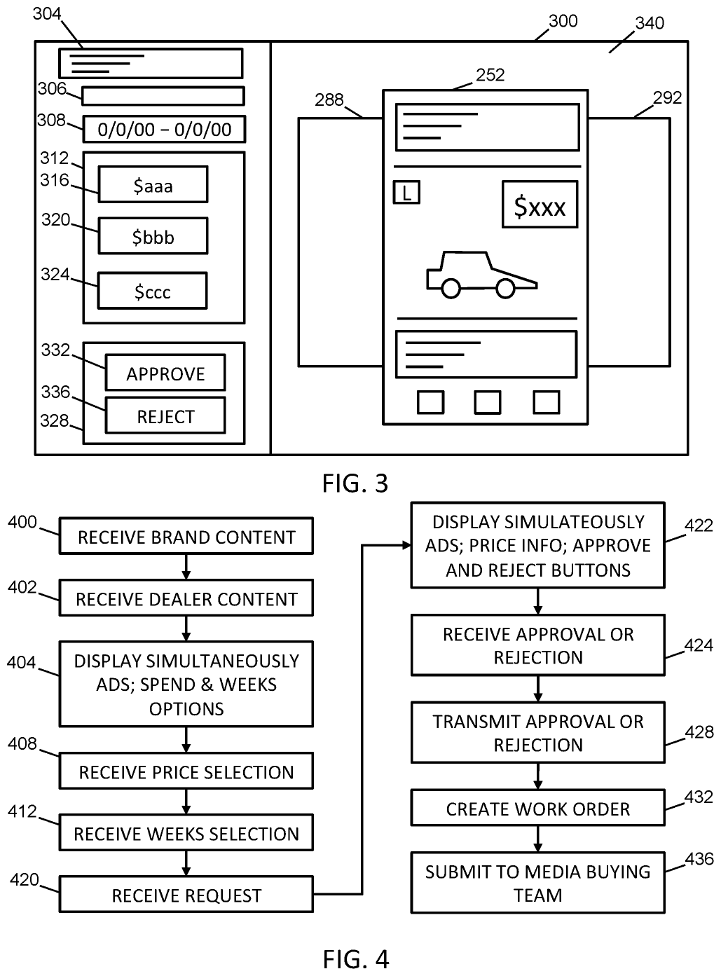

Referring to FIG. 3, there is shown an approval GUI 300 shown to the brand 120. This GUI 300 is shown to the brand 120 after the dealer 124 has submitted the advertisements 252, 288, 292 using GUI 200, e.g. after clicking or otherwise activating the submit button 250. In the upper left part of the GUI 300, there is an area 304 allocated for a welcome message to the brand 120 and the description of the required action, which may be, for example, to review and approve the submission of the advertisement campaign by the dealer 124. Below the area 304, there is an area 306 that indicates the title of the advertisement campaign. Below the area 306, there is another area 308 that indicates the running dates of the advertisement campaign, based on the number of weeks selected by the dealer 124 using GUI 200 and either the date of submission of the request, the date of review of the submission, or another start date input by the dealer.

In the central part of the left side of the GUI 300, there is an area 312 that includes a summary of the spend (i.e. pricing information) for the advertisement campaign. The value 316 indicates the total advertisement spend, the value 320 indicates the net amount that the dealer 124 pays for and the value 324 indicates the amount that the brand pays, for example in the form of a reimbursement from the brand to the dealer.

At the bottom part of the left section of the GUI 300, there is an area 328 that includes an approve button 332 and a reject button 336. Area 328 may be described as a review interface. The brand 120 uses one of the two buttons 332 and 336 by clicking on it to send his approval or rejection of the dealer's submission. In response to the brand 120 clicking or otherwise activating the approve button 332, the advertisements 252, 288, 292 are published, or a work order is created by the system 100 to have them published.

On the right side 340 of the GUI 300, there is an area in which the dealer's proposed advertisements 252, 288, 292 are displayed. The advertisements 252, 288, 292 appear in the GUI 300 exactly as they would appear when published, taking into account the different devices and browsers in which they may be displayed. The brand 124 can click on the advertisements 288, 292 that are in the background to bring them into the foreground for review.

The main features of GUI 300 are an area 340 to view the proposed advertisements 252, 288, 292, an area 308 that displays the run dates of the advertisements, an area 312 that displays the pricing information of the advertisements, and an area 328 that allows the submitted advertisements to be approved or rejected, all these areas being displayed simultaneously.

Referring to FIG. 4, there is shown a flowchart that describes the functioning steps of the system 100. The system 100 receives content from the brand 120 in step 400. The content from the brand 120 includes at least a template, a logo and an image. The logos and images are fixed according to the brand's requirements, and cannot be changed by the dealer 124. The system 100 then receives the dealer content in step 402. Then, the system 100 displays simultaneously the advertisements created using the templates and the dealer content, the weekly spend options and the number of weeks options in step 404. The system 100 receives the price selection from the dealer 124 in step 408. Next, the system 100 receives the number of weeks selection from the dealer 124 in step 412.

In step 420, the system receives the request for approval of the advertisement campaign from the dealer 124. The system 100 then displays, to the brand 120, simultaneously the advertisements and price information (e.g. total spend), with approve and reject buttons for the brand in step 422.

Then, the system 100 receives the approval or the rejection from the brand 120 in step 424. Approval or rejection is provided to the system 100 by the activation by the brand 120 of either the approve button 332 or the reject button 336 respectively. The system 100 transmits notification of the approval or the rejection to the dealer in step 428. The system 100 creates a work order for placing the advertisements in step 432. The system 100 submits the work order to the media buying team 108 in step 436.

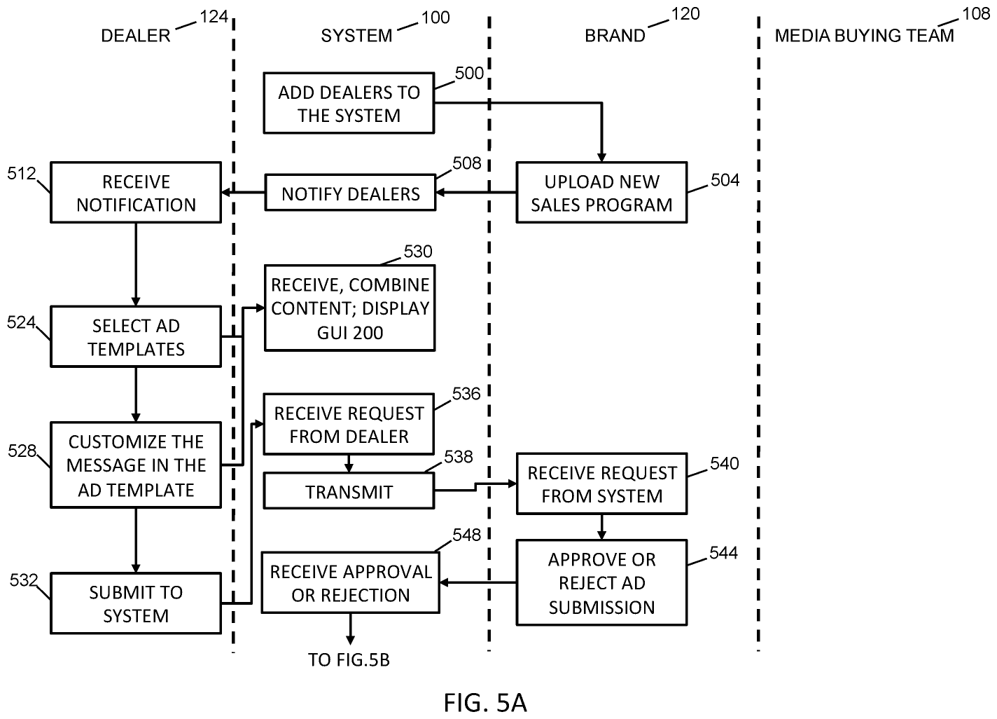

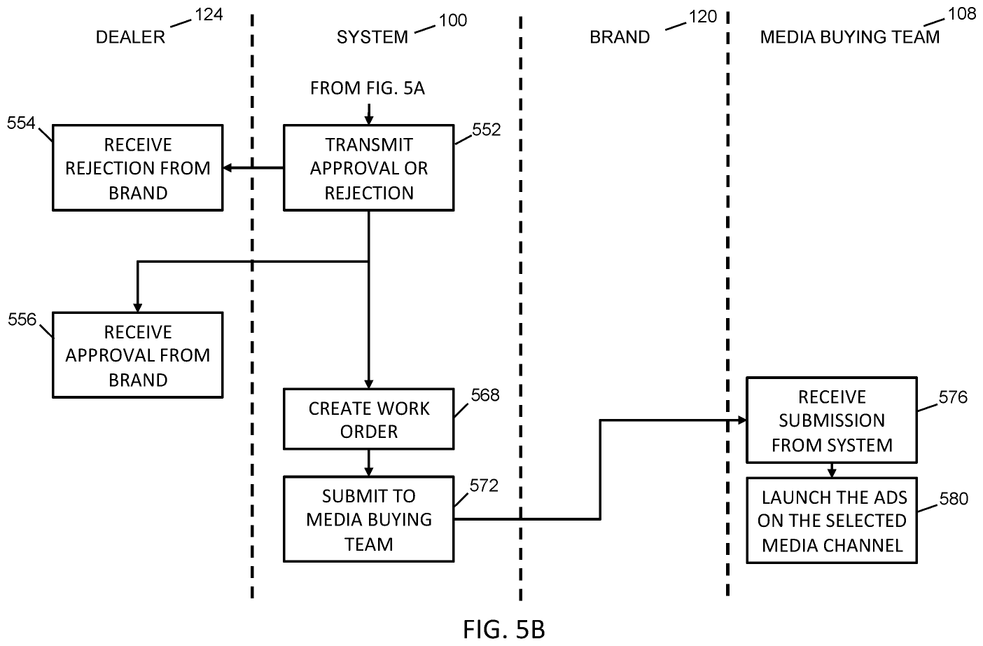

Referring to FIG. 5A, there is shown a swim lane diagram representing the process carried out by and with the system 100. In step 500, a list of dealers is added by the brand 120, for example, to the system 100. Other parties may upload dealer information to the system 100 in other embodiments. After the brand 120 has created a new sales program, either using the system 100 or separate from the system, the brand either notifies the system that there is a new sales program or uploads the new sales program to the system, in step 504. In step 508, the system 100 notifies the dealer 124 of the new sales program. The dealer 124 then receives the notification for the new sales program from the system 100 in step 512. The new sales program may be one of several sales programs available to the dealer 124.

Next, if the dealer 124 wishes to participate in a sales program, he selects a template in step 524. Essentially, the templates are media channel and sales program specific, so it eliminates the need for the dealer to select a specific media channel and sales program. The templates include default messages that can be edited, or blank spaces for the dealer to write in. However, in some embodiments, the messages are predetermined and are not able to be edited by the dealer. In step 528, the dealer optionally customizes the message or messages that he wishes to appear in the advertisement. Steps 524 and 528 are is undertaken by the dealer 124 via interaction with the system 100, which receives the selections and content from the dealer in step 530, and combines it into one or more advertisements.

If the dealer 124 is satisfied with the advertisements that the system 100 has produced from combining the selections and content supplied by the dealer, then, in step 532, the dealer submits the advertisements, including the dealer's proposed advertisement run time and spend, to the brand 120. The system 100 receives the request from the dealer 124 in step 536. The system 100 transmits the request to the brand 120 in step 538. The brand 120 receives the request from the system 100 in step 540. The brand 120 approves or rejects the advertisement submission in step 544. The system 100 receives the approval or the rejection from the brand in step 548.

Referring to FIG. 5B, which is a continuation of FIG. 5A, there is shown the remainder of the swimlane diagram representing the process. The system 100 transmits the approval or rejection to the dealer in step 552. If, in step 554, the dealer 124 receives a rejection from the brand 120, the process stops. The dealer 124 still has the option of preparing another submission of an advertising campaign to the brand 120.

If, in step 556, the dealer 124 receives an approval from the brand 120, the process continues. The system 100 creates a work order for the advertisements in step 568. The system 100 submits the work order to the media buying team 108 in step 572. The media buying team 108 receives the work order submission from the system 100 in step 576. Then, the media buying team 108 launches the advertisements on the selected media channel or channels in step 580.

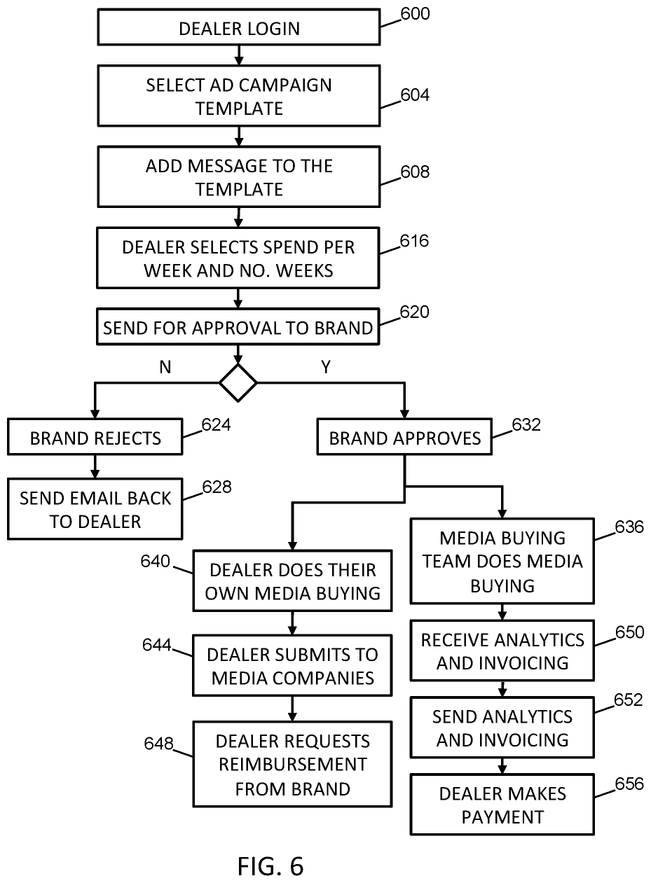

Referring to FIG. 6, there is shown a flowchart of the process from the dealer's point of view. The dealer 124 logs into the system 100 in step 600. Then in step 604, the dealer selects the advertisement campaign features such as the advertisement campaign template(s). In some embodiments, the dealer 124 enters information (e.g. a message) and customizes the advertisement campaign template in step 608, and/or arranges the information and the images in the advertisement campaign template. The dealer 124 then selects the proposed spend per week and the number of weeks the advertisements are to run in step 616.

The dealer 124 then sends the customized advertisement campaign for approval to the brand 120 in step 620. If the brand 120 rejects the customized advertisement campaign in step 624, then an email is sent back to the dealer 124 to inform him that the customized advertisement campaign proposal has been rejected in step 628. If the brand 120 approves the customized advertisement campaign in step 632, then there are two options: the company running the system 100 controls the media buying in step 636 or the dealer 124 does their own media buying in step 640. If the dealer 124 does their own media buying in step 640, then the dealer submits the customized advertisements to the media companies for publication in step 644. After that, and assuming that the dealer 124 has paid the media companies for running the advertisements, the dealer requests reimbursement from the brand 120 in step 648 for the portion of the advertising spend that the brand offered and approved.

In the case that the media buying team 108 does the media buying in step 636, the media buying team enters into a contract with the media channels, which then run the advertisements. After the advertisements have run, the media buying team 108 receives the analytics related to the advertising and receives an invoice from the media channels in step 650. The media buying team 108 then sends the analytics and invoicing to the brand 120, dealer 124 or other stakeholder in step 652. Then, the payment from the dealer is made in step 656. Payment is, for example, a portion of the total advertisement spend, the other portion having been paid by the brand 120. In other embodiments, the dealer 124 may make payment before the advertisements are run.

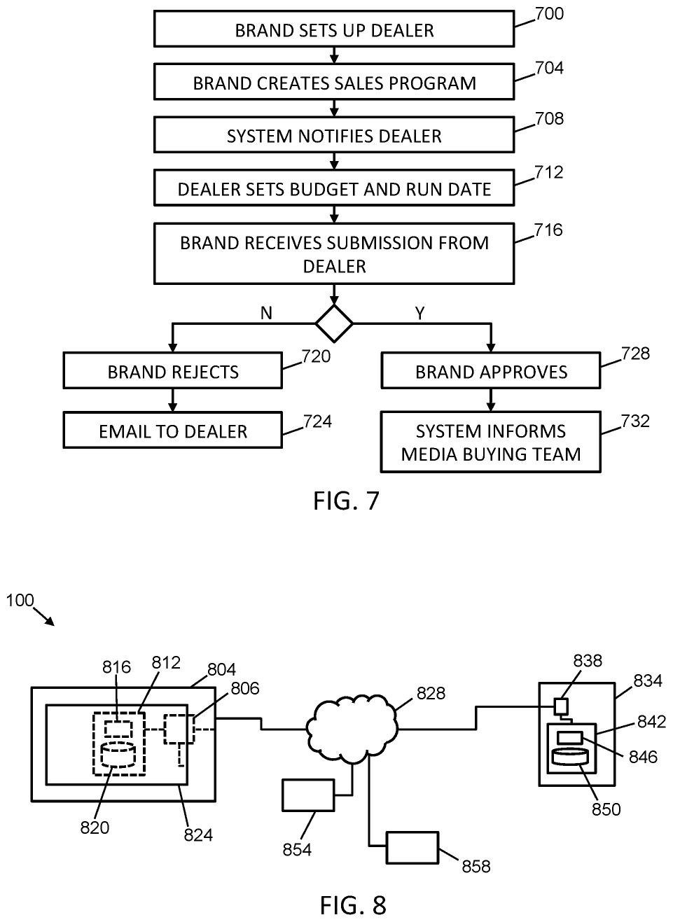

Referring to FIG. 7, there is shown a flowchart representing the brand's point of view, for example using a white label version of the system 100. In step 700, the brand 120 sets up the dealers 124 in the system 100. Then, in step 704, the brand creates the sales program by choosing, for example, the design and layout of the advertisement templates, the choice of logos and the choice of images. For example, the brand 120 may initially choose to submit to the system 100 several different layouts or logos with various graphical elements.

In step 708, the system 100 sends notification of the sales program to the dealer 124 in order for the dealer to select the desired sales program and advertisement campaign templates and the options related to the sales program.

The dealer 124 sets the budget and run time for the advertisement campaign request in step 712. The brand 120 then receives an advertisement campaign submission from the dealer 124 in step 716. If the brand 120 rejects the dealer's proposal in step 720, then a rejection email or other notification is sent back to the dealer in step 724. If the brand 120 approves the advertisement campaign in step 728, then the media buying team 108 attends to the placing of the advertisements in step 732.

Referring to FIG. 8, the system 100 includes or interacts with a user computing device 804, which may be a laptop or desktop computer, for example, or any other electronic device that provides the necessary equivalent functionality to fulfill the requirements of the invention. The user device 804 includes one or more processors 806 which are operably connected to computer readable memory 812 included in the device. The system 100 includes computer readable instructions 816 (e.g. an application) stored in the memory 812 and computer readable data 820, also stored in the memory. The memory 812 may be divided into one or more constituent memories, of the same or different types. The user device 804 includes a display screen 824, operably connected to the processor(s) 806. The display screen 824 may be a traditional screen, a touch screen, a projector, an electronic ink display or any other technological device for displaying information.

The user device 804 is connected to or into the system 100 via a network 828, which may, for example, be the internet, a telecommunications network, a local area network, a bespoke network or any combination of the foregoing. Communications paths in the network 828 may include any type of point-to-point or broadcast system or systems. The user device is connected to the network 828 wirelessly (e.g. by Wi-Fi® Bluetooth®) or via a wired connection. Other users may have further user devices 854, 858 with functionally equivalent components to those of device 804, which may also be part of, or connected to, the system 100. User devices 854, 858 may be portable or non-portable computing terminals.

The system 100 also includes a server 834, which has one or more processors 838 operably connected to a computer readable memory 842, which stores computer readable instructions 846 and computer readable data 850. Data 850 may be stored in a relational database, for example. Some or all of the computer readable instructions 816, 846 and computer readable data 820, 850 provide the functionality of the system 100 when executed or read by one or more of the processors 806, 838. Computer readable instructions may be broken down into blocks of code or modules.

### C. Variations

The layouts of the GUIs 200, 300 are different in other embodiments, provided that they still simultaneously display the requisite components.

While the invention has been described mainly in relation to the publication of advertisements, it may also be applied in the publication of other content. For example, it may be used for the publication of brochures for houses that are on sale, which require input of content from a real estate agent and from the brand under which the agent operates.

In general, unless otherwise indicated, singular elements may be in the plural and vice versa with no loss of generality. The masculine gender includes the feminine.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. Accordingly, the specification is to be regarded in an illustrative, rather than a restrictive, sense.

It will be clear to one having skill in the art that further variations to the specific details disclosed herein can be made, resulting in other embodiments that are within the scope of the invention disclosed. Steps in the flowcharts may be performed in a different order, other steps may be added, or one or more may be removed without altering the main function of the invention. All configurations described herein are examples only and actual ones of such depend on the specific embodiment. Accordingly, the scope of the invention is to be construed in accordance with the substance defined by the following claims.

### D. Claim Support

Disclosed is a method for reviewing cooperatively produced content comprising: receiving, by a system, first content from a first user comprising a template, a logo and an image; receiving, by the system, second content from a second user comprising a message; combining, by the system, the first and second content to form the cooperatively produced content; receiving, by the system from the second user, a selection of a price per week; receiving, by the system from the second user, a selection of a number of weeks; calculating, by the system, a total price by multiplying the price per week by the number of weeks; displaying simultaneously, by the system to the first user, the cooperatively produced content in a first area of a screen, the total price in a second area of the screen, and a review interface in a third area of the screen; and receiving an input from the first user via the review interface.

In some embodiments, the review interface comprises an approve button and a reject button; and the input is an activation of the approve button or the reject button.

In some embodiments, the input is an activation of the approve button, and the method comprises publishing the cooperatively produced content in response to the input.

In some embodiments, the publishing has a cost equal to the total price and the second content comprises a message.

In some embodiments, the method comprises, after the combining step: displaying simultaneously, by the system to the second user, the cooperatively produced content in a first area of a second screen, multiple prices per week of which one price per week is selectable in a second area of the second screen, multiple numbers of weeks of which one number is selectable in a third area of the second screen; and a submit button in a fourth area of the second screen; wherein the selection of the price per week is a selection of a displayed price per week, and the selection of the number of weeks is a selection of a displayed number of weeks.

In some embodiments, the displaying to the first user is in response to the system detecting an activation of the submit button.

In some embodiments, the method comprises displaying the total price in a fifth area of the second screen simultaneously with the displaying in the first to fourth areas of the second screen.

In some embodiments, the cooperatively produced content is displayed exactly as it would appear when published.

In some embodiments, the first user is a brand and the second user is a dealer of the brand.

Also disclosed is a system for reviewing cooperatively produced content comprising a processor; a first user device having a first screen; computer readable memory carrying computer readable instructions, which, when executed by the processor cause the system to: receive first content from a first user comprising a template, a logo and an image; receive second content from a second user; combine the first and second content to form the cooperatively produced content; receive from the second user, a selection of a price per week; receive from the second user, a selection of a number of weeks; calculate a total price by multiplying the price per week by the number of weeks; display simultaneously on the first screen, to the first user, the cooperatively produced content in a first area of the first screen, the total price in a second area of the first screen, and a review interface in a third area of the first screen; and receive an input from the first user via the review interface.

In some embodiments, the review interface comprises an approve button and a reject button; and the input is an activation of the approve button or the reject button.

In some embodiments, the input is an activation of the approve button, the computer readable instructions, when executed by the processor, cause the system to generate a work order for publishing the cooperatively produced content.

In some embodiments, the system comprises a second screen, wherein: after the combine step, the computer readable instructions, when executed by the processor, cause the system to display simultaneously on the second screen, to the second user, the cooperatively produced content in a first area of the second screen, multiple prices per week of which one price per week is selectable in a second area of the second screen, multiple numbers of weeks of which one number is selectable in a third area of the second screen; and a submit button in a fourth area of the second screen; the selection of the price per week is a selection of a displayed price per week, and the selection of the number of weeks is a selection of a displayed number of weeks; and the display to the first user is in response to the system detecting an activation of the submit button.

In some embodiments, the computer readable instructions, when executed by the processor, cause the system to display the total price in a fifth area of the second screen simultaneously with the displays in the first to fourth areas of the second display.

In some embodiments, the logo and the image cannot be altered by the second user.

Further disclosed is a computer readable memory carrying computer readable instructions, which, when executed by a processor cause a system to: receive first content from a first user comprising a template, a logo and an image; receive second content from a second user; combine the first and second content to form the cooperatively produced content; receive from the second user, a selection of a price per week; receive from the second user, a selection of a number of weeks; calculate a total price by multiplying the price per week by the number of weeks; display simultaneously on a first screen, to the first user, the cooperatively produced content in a first area of the first screen, the total price in a second area of the first screen, and a review interface in a third area of the first screen; and receive an input from the first user via the review interface.

In some embodiments, the review interface comprises an approve button and a reject button; and the input is an activation of the approve button or the reject button.

In some embodiments, the input is an activation of the approve button, the computer readable instructions, when executed by the processor, cause the system to generate a work order for publishing the cooperatively produced content.

In some embodiments, after the combine step, the computer readable instructions, when executed by the processor, cause the system to display simultaneously on a second screen, to the second user, the cooperatively produced content in a first area of the second screen, multiple prices per week of which one price per week is selectable in a second area of the second screen, multiple numbers of weeks of which one number is selectable in a third area of the second screen, and a submit button in a fourth area of the second screen; the selection of the price per week is a selection of a displayed price per week, and the selection of the number of weeks is a selection of a displayed number of weeks; and the display to the first user is in response to the system detecting an activation of the submit button.

In some embodiments, the computer readable instructions, when executed by the processor, cause the system to display the total price in a fifth area of the second screen simultaneously with the displays in the first to fourth areas of the second display.

1. A method for reviewing cooperatively produced content comprising:
receiving, by a system, first content from a first user comprising a template, a logo and an image;
receiving, by the system, second content from a second user;
combining, by the system, the first and second content to form the cooperatively produced content;
receiving, by the system from the second user, a selection of a price per week;
receiving, by the system from the second user, a selection of a number of weeks;
calculating, by the system, a total price by multiplying the price per week by the number of weeks;
displaying simultaneously, by the system to the first user, the cooperatively produced content in a first area of a screen, the total price in a second area of the screen, and a review interface in a third area of the screen; and
receiving an input from the first user via the review interface.

2. The method of claim 1, wherein:
the review interface comprises an approve button and a reject button; and
the input is an activation of the approve button or the reject button.

3. The method of claim 2, wherein the input is an activation of the approve button, and the method comprises publishing the cooperatively produced content in response to the input.

4. The method of claim 3, wherein:
the publishing has a cost equal to the total price; and
the second content comprises a message.

5. The method of claim 1, comprising, after the combining step:
displaying simultaneously, by the system to the second user, the cooperatively produced content in a first area of a second screen, multiple prices per week of which one price per week is selectable in a second area of the second screen, multiple numbers of weeks of which one number is selectable in a third area of the second screen; and a submit button in a fourth area of the second screen;
wherein the selection of the price per week is a selection of a displayed price per week, and the selection of the number of weeks is a selection of a displayed number of weeks.

6. The method of claim 5, wherein the displaying to the first user is in response to the system detecting an activation of the submit button.

7. The method of claim 5, comprising displaying the total price in a fifth area of the second screen simultaneously with the displaying in the first to fourth areas of the second screen.

8. The method of claim 5, wherein the cooperatively produced content is displayed exactly as it would appear when published.

9. The method of claim 1, wherein the first user is a brand and the second user is a dealer of the brand.

10. A system for reviewing cooperatively produced content comprising:
a processor;
a first user device having a first screen;
computer readable memory carrying computer readable instructions, which, when executed by the processor cause the system to:
receive first content from a first user comprising a template, a logo and an image;
receive second content from a second user;
combine the first and second content to form the cooperatively produced content;
receive from the second user, a selection of a price per week;
receive from the second user, a selection of a number of weeks;
calculate a total price by multiplying the price per week by the number of weeks;
display simultaneously on the first screen, to the first user, the cooperatively produced content in a first area of the first screen, the total price in a second area of the first screen, and a review interface in a third area of the first screen; and
receive an input from the first user via the review interface.

11. The system of claim 10, wherein:
the review interface comprises an approve button and a reject button; and
the input is an activation of the approve button or the reject button.

12. The system of claim 11, wherein, when the input is an activation of the approve button, the computer readable instructions, when executed by the processor, cause the system to generate a work order for publishing the cooperatively produced content.

13. The system of claim 10 comprising a second screen, wherein:
after the combine step, the computer readable instructions, when executed by the processor, cause the system to display simultaneously on the second screen, to the second user, the cooperatively produced content in a first area of the second screen, multiple prices per week of which one price per week is selectable in a second area of the second screen, multiple numbers of weeks of which one number is selectable in a third area of the second screen; and a submit button in a fourth area of the second screen;
the selection of the price per week is a selection of a displayed price per week, and the selection of the number of weeks is a selection of a displayed number of weeks; and
the display to the first user is in response to the system detecting an activation of the submit button.

14. The system of claim 13, wherein the computer readable instructions, when executed by the processor, cause the system to display the total price in a fifth area of the second screen simultaneously with the displays in the first to fourth areas of the second display.

15. The system of claim 10, wherein the logo and the image cannot be altered by the second user.

16. A computer readable memory carrying computer readable instructions, which, when executed by a processor cause a system to:
receive first content from a first user comprising a template, a logo and an image;
receive second content from a second user;
combine the first and second content to form the cooperatively produced content;
receive from the second user, a selection of a price per week;
receive from the second user, a selection of a number of weeks;
calculate a total price by multiplying the price per week by the number of weeks;
display simultaneously on a first screen, to the first user, the cooperatively produced content in a first area of the first screen, the total price in a second area of the first screen, and a review interface in a third area of the first screen; and
receive an input from the first user via the review interface.

17. The computer readable memory of claim 16, wherein:
the review interface comprises an approve button and a reject button; and
the input is an activation of the approve button or the reject button.

18. The computer readable memory of claim 17, wherein, when the input is an activation of the approve button, the computer readable instructions, when executed by the processor, cause the system to generate a work order for publishing the cooperatively produced content.

19. The computer readable memory of claim 16, wherein:
after the combine step, the computer readable instructions, when executed by the processor, cause the system to display simultaneously on a second screen, to the second user, the cooperatively produced content in a first area of the second screen, multiple prices per week of which one price per week is selectable in a second area of the second screen, multiple numbers of weeks of which one number is selectable in a third area of the second screen, and a submit button in a fourth area of the second screen;
the selection of the price per week is a selection of a displayed price per week, and the selection of the number of weeks is a selection of a displayed number of weeks; and
the display to the first user is in response to the system detecting an activation of the submit button.

20. The computer readable memory of claim 18, wherein the computer readable instructions, when executed by the processor, cause the system to display the total price in a fifth area of the second screen simultaneously with the displays in the first to fourth areas of the second display.
